(19) United States
(12) Patent Application Publication
(10) Pub. No.: US 2018/0216631 A1
(43) Pub. Date: Aug. 2, 2018

(54) GEARED GAS TURBINE ENGINE

(71) Applicant: ROLLS-ROYCE plc, London (GB)

(72) Inventors: Stewart T. THORNTON, Derby (GB); Nicholas E. CHILTON, Derby (GB)

(73) Assignee: ROLLS-ROYCE plc, London (GB)

(21) Appl. No.: 15/881,879

(22) Filed: Jan. 29, 2018

(30) Foreign Application Priority Data
Feb. 1, 2017 (GB) 1701630.4

(51) Int. Cl. F04D 29/54; F02C 7/36

(52) U.S. Cl. CPC F04D 29/542; F02K 3/06; F02C 7/36

(57) ABSTRACT

A geared gas turbine engine comprises at least one compressor, at least one turbine, a fan, a gearbox and a support structure. At least one turbine is arranged to drive the fan via the gearbox. The fan is rotatably mounted in the support structure and the support structure supports the gearbox. The support structure includes a stator vane arrangement comprising a plurality of circumferentially spaced stator vanes extending radially between inner and outer annular walls. The inner annular wall has two axially spaced radially inwardly extending annular flanges and a plurality of circumferentially spaced buttresses extending axially between the annular flanges. The outer annular wall has two axially spaced radially outwardly extending annular flanges and a plurality of circumferentially buttresses extending axially between the annular flanges. The flanges and buttresses increase the strength of the support structure to carry the torque loads of the gearbox.

### CROSS-REFERENCE TO RELATED APPLICATIONS

This disclosure claims the benefit of GB Patent Application No. GB 1701630.4, filed on 1 Feb. 2017, which is hereby incorporated herein in its entirety.

### FIELD OF THE DISCLOSURE

The present disclosure relates to a geared gas turbine engine and in particular to a geared turbofan gas turbine engine.

### BACKGROUND

Conventionally a turbofan gas turbine engine generally comprises a high pressure compressor driven directly by a high pressure turbine via a high pressure shaft and a fan which is directly driven by a low pressure turbine via a low pressure shaft. The turbofan may either comprise an intermediate pressure compressor driven directly by an intermediate pressure turbine via an intermediate pressure shaft or an intermediate pressure compressor driven directly by the low pressure turbine via the low pressure shaft. The fan is rotatably mounted in a support structure by at least one bearing. The intermediate pressure compressor is also rotatably mounted in the support structure by at least one bearing if the intermediate pressure compressor is driven directly by an intermediate pressure turbine. The support structure comprises a stator vane arrangement which is arranged in flow series between the fan and the intermediate pressure compressor. The stator vane arrangement comprises a plurality of circumferentially spaced stator vanes extending radially between an inner annular wall and an outer annular wall. The stator vanes may be hollow to supply lubricant to, and/or remove lubricant from, the at least one bearing for the fan or the stator vanes may be hollow to supply lubricant to, and/or remove lubricant from, the at least one bearing for the fan and the at least one bearing for the intermediate pressure compressor. The support structure, and in particular the stator vane arrangement, transmits radial loads from the fan, or the fan and the intermediate pressure compressor, to the core engine structure. The core engine structure comprises a plurality of axially spaced support structures and casings interconnecting the support structures. Each support structure rotatably mounts one or more of the rotating components, e.g. the fan, the intermediate pressure compressor, the high pressure compressor, the high pressure, turbine, the intermediate pressure turbine or the low pressure turbine, via a bearing.

Currently turbofan gas turbine engines are being developed in which the high pressure compressor is driven directly by the high pressure turbine, the intermediate pressure compressor is driven directly by the low pressure turbine and the fan is driven by the low pressure turbine via a gearbox. The use of a gearbox to drive the fan results in large torque loads and radial loads, or bearing loads, which have to be transmitted through the support structure to the core engine structure. The support structure, and in particular the stator vane arrangement, transmits the torque loads and the radial loads, or bearing loads, from the fan and the gearbox to the core engine structure. However, it has been found that the current stator vane arrangement is not strong enough to transmit the large torque loads and the radial loads or bearing loads.

### SUMMARY OF THE DISCLOSURE

Accordingly the present disclosure seeks to provide a geared gas turbine engine which reduces or overcomes the above mentioned problem.

According to a first aspect of the present disclosure there is provided a geared gas turbine engine comprising at least one compressor, at least one turbine, at least one propulsor, a gearbox and a support structure, the at least one turbine being arranged to drive the at least one compressor, the at least one turbine being arranged to drive the least one propulsor via the gearbox, the at least one propulsor being arranged upstream of the at least one compressor, the gearbox being arranged between the at least one compressor and the at least one propulsor, the at least one propulsor being rotatably mounted in the support structure and the support structure supporting the gearbox, the support structure including a stator vane arrangement comprising a plurality of circumferentially spaced stator vanes extending radially between an inner annular wall and an outer annular wall, the stator vane arrangement being arranged in flow series between the fan and the at least one compressor, the inner annular wall having a first radially inwardly extending annular flange, a second radially inwardly extending annular flange spaced axially downstream from the first radially extending annular flange and a plurality of circumferentially spaced radially inwardly extending buttresses extending axially from the first radially inwardly extending annular flange to the second radially inwardly extending annular flange, the outer annular wall having a first radially outwardly extending annular flange, a second radially outwardly extending annular flange spaced axially downstream from the first radially extending annular flange and a plurality of circumferentially spaced radially outwardly extending buttresses extending axially from the first radially outwardly extending annular flange to the second radially outwardly extending annular flange.

Each stator vane may comprise a radially inner end, a radially outer end, a leading edge, a trailing edge, a first surface extending from the leading edge to the trailing edge and from the radially inner end to the radially outer end and a second surface extending from the leading edge to the trailing edge and from the radially inner end to the radially outer end. The radially inner end of each stator vane may be secured to the inner annular wall and the radially outer end of each stator vane being secured to the outer annular wall.

The first surface may be concave between the leading edge and the trailing edge and the second surface may be convex between the leading edge and the trailing edge.

The first radially inwardly extending annular flange and the radially inner ends of the leading edges of the stator vanes may be arranged at the same axial position. The first radially inwardly extending annular flange may be arranged axially downstream of the radially inner ends of the leading edges of the stator vanes.

The second radially inwardly extending annular flange and the radially inner ends of the trailing edges of the stator vanes may be arranged at the same axial position. The second radially inwardly extending annular flange may be arranged axially upstream of the radially inner ends of the trailing edges of the stator vanes.

The radially inwardly extending buttresses may extend axially downstream from the second radially inwardly extending annular flange.

Each radially inwardly extending buttress may be circumferentially aligned with a corresponding one of the stator vanes.

Each radially inwardly extending buttress may comprise a lattice structure.

The first radially outwardly extending annular flange and the radially outer ends of the leading edges of the stator vanes may be arranged at the same axial position. The first radially outwardly extending annular flange may be arranged axially downstream of the radially outer ends of the leading edges of the stator vanes.

The second radially outwardly extending annular flange and the radially outer ends of the trailing edges of the stator vanes may be arranged at the same axial position. The second radially outwardly extending annular flange may be arranged axially upstream of the radially outer ends of the trailing edges of the stator vanes.

The radially outwardly extending buttresses may extend axially downstream from the second radially outwardly extending annular flange.

Each radially outwardly extending buttress may be circumferentially aligned with a corresponding one of the stator vanes.

Each radially outwardly extending buttress may comprise a lattice structure.

The leading edges of the stator vanes may be swept. The leading edges of the stator vanes may be swept rearwardly.

The stator vanes may be leant. The stator vanes may be leant at an angle of up to 10°. The stator vanes may be leant at an angle of 5°.

The stator vanes may be hollow.

The stator vane arrangement may be an integral, monolithic, unitary or single piece, structure. The stator vane arrangement may be a casting. The stator vane arrangement may be manufactured by casting. The stator vane arrangement may be manufactured by additive layer manufacturing. The stator vane arrangement may be manufactured by casting and additive layer manufacturing. The additive layer manufacturing may be powder bed laser deposition. The casting may be investment casting.

The stator vane arrangement may comprise a titanium alloy, a nickel alloy or steel.

The at least one compressor may be an intermediate pressure compressor and a high pressure compressor, the at least one turbine being a high pressure turbine and a low pressure turbine, the high pressure turbine being arranged to directly drive the high pressure compressor, the low pressure turbine being arranged to directly drive the intermediate pressure compressor and the low pressure turbine being arranged to drive the propulsor via the gearbox.

The gearbox may comprise a sun gear, an annulus gear, a plurality of planet gears and a planet gear carrier, the planet gears meshing with the sun gear and the annulus gear.

The at least one turbine may be arranged to drive the sun gear. The planet carrier may be arranged to drive the fan, the annulus gear being connected to the support structure and the carrier being rotatably mounted on the support structure. The annulus gear may be arranged to drive the fan, the planet carrier being connected to the support structure and the annulus gear being rotatably mounted on the support structure.

The at least one propulsor may be a fan or a propeller.

The skilled person will appreciate that except where mutually exclusive, a feature described in relation to any one of the above aspects of the invention may be applied mutatis mutandis to any other aspect of the invention.

### BRIEF DESCRIPTION OF THE DRAWINGS

Embodiments of the disclosure will now be described by way of example only, with reference to the Figures, in which:

FIG. 1 is a sectional side view of a geared gas turbine engine according to the present disclosure.

FIG. 2 is an enlarged cross-sectional view through the gearbox and the support structure of the geared gas turbine engine shown in FIG. 1.

FIG. 3 is a further enlarged cross-sectional view through a portion of the support structure shown in FIG. 2.

FIG. 4 is a view in the direction of arrow A in FIG. 3.

FIG. 5 is an alternative view in the direction of arrow A in FIG. 3.

FIG. 6 is another alternative view in the direction of arrow A in FIG. 3.

### DETAILED DESCRIPTION

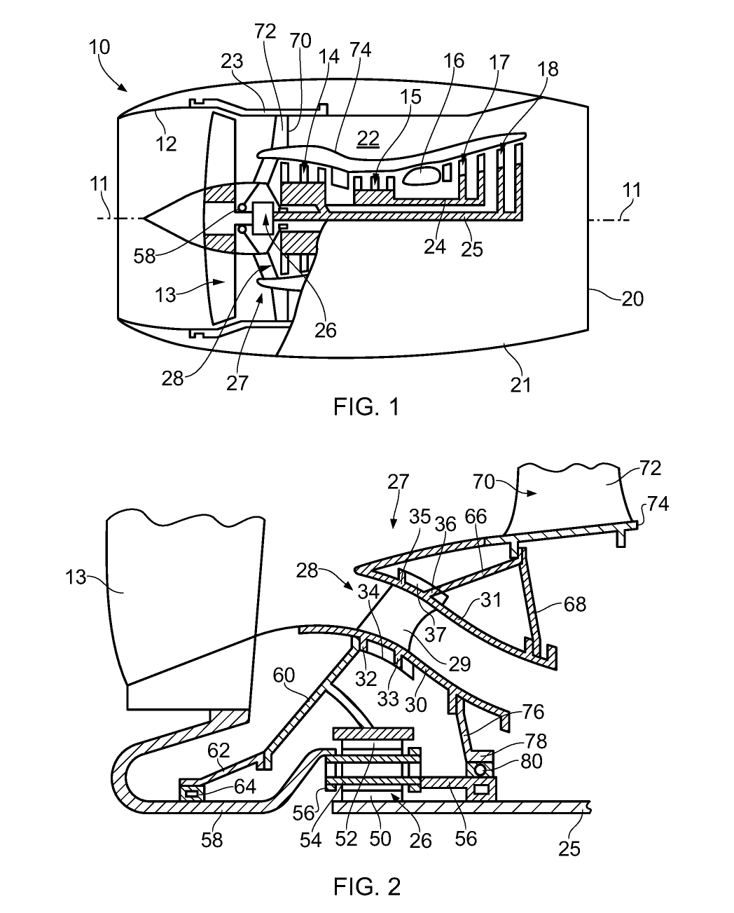

With reference to FIG. 1, a geared gas turbine engine is generally indicated at 10, having a principal and rotational axis 11. The geared gas turbine engine 10 comprises, in axial flow series, an air intake 12, a propulsive fan 13, an intermediate pressure compressor 14, a high-pressure compressor 15, combustion equipment 16, a high-pressure turbine 17, a low-pressure turbine 18 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive, the high and low pressure turbines 17 and 18 before being exhausted through the nozzle 20 to provide additional propulsive thrust. The high pressure turbine 17 drives the high pressure compressor 15 via a shaft 24, the low pressure turbine 18 drives the intermediate pressure compressor 14 directly via a shaft 25 and the low pressure turbine 18 also drives the fan 13 via the shaft 25 and a gearbox 26.

The fan 13 is arranged upstream of the intermediate and high pressure compressors 14 and 15 respectively and the gearbox 26 is arranged between, axially between, the intermediate pressure compressor 14 and the fan 13. The fan 13 is rotatably mounted in a support structure 27 and the support structure 27 supports the gearbox 26.

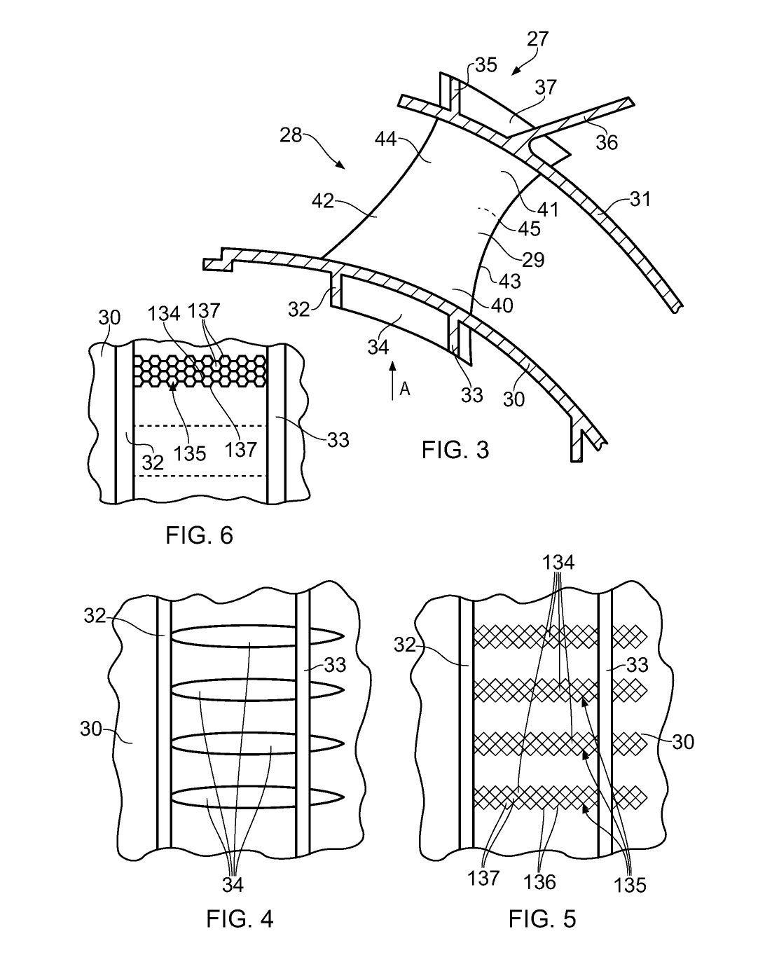

The support structure 27, as shown more clearly in FIGS. 2 to 4, comprises a stator vane arrangement 28 which comprises a plurality of circumferentially spaced stator vanes 29 extending radially between an inner annular wall 30 and an outer annular wall 31. The stator vane arrangement 28 is arranged in flow series between the fan 13 and the intermediate pressure compressor 14. The inner annular wall 30 has a first radially inwardly extending annular flange 32, a second radially inwardly extending annular flange 33 spaced axially downstream from the first radially extending annular flange 32 and a plurality of circumferentially spaced radially inwardly extending buttresses 34 extending axially from the first radially inwardly extending annular flange 32 to the second radially inwardly extending annular flange 33. The outer annular wall 31 has a first radially outwardly extending annular flange 35, a second radially outwardly extending annular flange 36 spaced axially downstream from the first radially extending annular flange 35 and a plurality of circumferentially spaced radially outwardly extending buttresses 37 extending axially from the first radially outwardly extending annular flange 35 to the second radially outwardly extending annular flange 36. The buttresses 34 and 37 are walls.

Each stator vane 29 comprises a radially inner end 40, a radially outer end 41, a leading edge 42, a trailing edge 43, a first surface 44 extending from the leading edge 42 to the trailing edge 43 and from the radially inner end 40 to the radially outer end 41 and a second surface 45 extending from the leading edge 42 to the trailing edge 43 and from the radially inner end 40 to the radially outer end 41. The radially inner end 40 of each stator vane 29 is secured to the inner annular wall 30 and the radially outer end 41 of each stator vane 29 is secured to the outer annular wall 31. The stator vanes 29 may be aerodynamically shaped and the first surface 44 of each stator vane 29 is concave between the leading edge 42 and the trailing edge 43 and the second surface 45 of each stator vane 29 is convex between the leading edge 42 and the trailing edge 43. Alternatively, the stator vanes 29 may have a different shape and the first surface 44 of each stator vane 29 is convex between the leading edge 42 and the trailing edge 43 and the second surface 45 of each stator vane 29 is convex between the leading edge 42 and the trailing edge 43.

The first radially inwardly extending annular flange 32 and the radially inner ends 40 of the leading edges 42 of the stator vanes 29 may be arranged at the same axial position. However, in this arrangement the first radially inwardly extending annular flange 32 is arranged axially downstream of the radially inner ends 40 of the leading edges 42 of the stator vanes 29.

The second radially inwardly extending annular flange 33 and the radially inner ends 40 of the trailing edges 43 of the stator vanes 29 may be arranged at the same axial position. However, in this example the second radially inwardly extending annular flange 33 is arranged axially upstream of the radially inner ends 40 of the trailing edges 43 of the stator vanes 29.

In this example the radially inwardly extending buttresses 34 extend axially downstream from the second radially inwardly extending annular flange 33. The radially inwardly extending buttresses 34 may extend axially upstream from the first radially inwardly extending annular flange 32. The radially inwardly extending buttresses 34 may only extend in a downstream direction to the second radially inwardly extending annular flange 33. Each radially inwardly extending buttresses 34 is circumferentially aligned with a corresponding one of the stator vanes 29.

The first radially outwardly extending annular flange 35 and the radially outer ends 41 of the leading edges 42 of the stator vanes 29 may be arranged at the same axial position. However, in this example the first radially outwardly extending annular flange 35 is arranged axially downstream of the radially outer ends 41 of the leading edges 32 of the stator vanes 29.

The second radially outwardly extending annular flange 36 and the radially outer ends 41 of the trailing edges 43 of the stator vanes 29 may be arranged at the same axial position. However, in this example the second radially outwardly extending annular flange 36 is arranged axially upstream of the radially outer ends 41 of the trailing edges 43 of the stator vanes 29.

In this example the radially outwardly extending buttresses 37 extend axially downstream from the second radially outwardly extending annular flange 36 and the radially outwardly extending buttresses 37 extend axially upstream from the first radially outwardly extending annular flange 35. The radially outwardly extending buttresses 37 may only extend in a downstream direction to the second radially outwardly extending annular flange 36. The radially outwardly extending buttresses 37 may only extend in an upstream direction to the first radially outwardly extending annular flange 35. Each radially outwardly extending buttresses 37 is circumferentially aligned with a corresponding one of the stator vanes 29.

The leading edges 42 of the stator vanes 29 may be swept and in particular the leading edges 42 of the stator vanes 29 may be swept rearwardly, e.g. the radially outer ends 41 of the stator vanes 29 are displaced axially downstream from the radially inner ends 40 of the stator vanes 29.

The stator vanes 29 may be leant, e.g. the radially outer end 41 of each stator vane 29 may displaced circumferentially from the radially inner end 40 of the stator vane 29. The stator vanes 29 may be leant at an angle of up to 10°. The stator vanes 29 may be leant at an angle of 5°.

The stator vanes 29 may be hollow and may have pipes extending there-through for the supply of lubricant to and/or from the bearings 64 and gearbox 26.

The stator vane arrangement 28, e.g. the inner annular wall 30, the outer annular wall 32, the plurality of stator vanes 29, the flanges 32, 33, 34 and 35 and the buttresses 34 and 37 may be an integral, monolithic, unitary or single piece, structure. The stator vane arrangement 28 may be a casting manufactured by casting, e.g. investment casting. The stator vane arrangement 28 may alternatively be manufactured by additive layer manufacturing. The stator vane arrangement 28 may be manufactured by casting and additive layer manufacturing, e.g. the inner annular wall 30, the outer annular wall 32, the plurality of stator vanes 29, the flanges 32, 33, 34 and 35 may be an integral, monolithic, unitary or single piece, structure produced by casting and the buttresses may be produced on the stator vane arrangement 28 by additive layer manufacturing. The additive layer manufacturing may be powder bed laser deposition. The stator vane arrangement 28 may comprise a titanium alloy, a nickel alloy or steel.

The gearbox 26, as shown in FIG. 2, comprises a sun gear 50, an annulus gear 52, a plurality of planet gears 54 and a planet gear carrier 56. The planet gears 54 mesh with the sun gear 50 and the annulus gear 52. The sun gear 50 is driven by the shaft 25 and hence the low pressure turbine 18 drives the sun gear 50 via the shaft 25. The planet gear carrier 56 is arranged to drive the fan 13 via a shaft 58 and the annulus gear 52 is connected to the support structure 27 and the planet gear carrier 56 is rotatably mounted on the support structure 27.

The support structure 27 further comprises a first frustoconical member 60, a bearing housing 62 and at least one bearing 64. The first frustoconical member 60 extends radially inwardly from the first radially inwardly extending annular flange 32, the radially inner end of the first frustoconical member 60 is secured to and supports the bearing housing 62 and the bearing housing 62 has the at least one bearing 64 to rotatably mount the fan 13 and the shaft 58. The at least one bearing 64 may be a roller bearing and/or a ball bearing.

The support structure 27 further comprises a second frustoconical member 66 and an annular radially outwardly extending member 68. The second frustoconical member 66 extends radially outwardly from the second radially outwardly extending annular flange 36. The radially inner end of the annular radially outwardly extending member 68 is secured to the outer annular wall 31 downstream of the second radially outwardly extending annular flange 37 and the radially outer end of the second frustoconical member 66 is secured to the radially outer end of the annular radially outwardly extending member 68. The radially outer end of the second frustoconical member 66 and the radially outer end of the annular radially outwardly extending member 68 are secured to the radially inner end of a fan outlet guide vane arrangement 70. The fan outlet guide vane arrangement 70 comprises a plurality of circumferentially spaced fan outlet guide vanes 72 which extend radially across the fan duct 22 from a core engine casing 74 to the fan casing 23 and the nacelle 21.

The support structure 27 also comprises a third frustoconical member 76, a bearing housing 78 and at least one bearing 80. The third frustoconical member 76 extends radially inwardly from the inner annular wall 30, the radially inner end of the third frustoconical member 76 is secured to and supports the bearing housing 78 and the bearing housing 78 has the at least one bearing 80 to rotatably mount the planet gear carrier 56. The at least one bearing 80 may be a roller bearing and/or a ball bearing.

In operation the torque and radial loads, or bearing loads, from the gearbox 26 and the bearings 64 and 80 are carried by the support structure 27 and in particular the torque and bearing loads are transmitted through the first and third frustoconical members 60 and 76 to the inner annular wall 30 of the stator vane arrangement 28. The torque and bearing loads are then transmitted through the stator vanes 29 to the outer annular wall 31 and then through the second frustoconical member 66 and the annular radially extending member 68 to the fan outlet guide vane arrangement 70. The torque and bearing loads are thus transmitted into the core engine structure. The inner annular wall 30, the first and second radially inwardly extending annular flanges 32 and 33 and the buttresses 34 form a stiff structure and the outer annular wall 31, the first and second radially outwardly extending annular flanges 35 and 36 and the buttresses 37 form a further stiff structure.

The first and second radially inwardly extending annular flanges 32 and 33 and the buttresses 34 increase the strength of the inner annular wall 30 and the first and second radially outwardly extending annular flanges 35 and 36 and the buttresses 37 increase the strength of the outer annular wall 31 so that the stator vane arrangement 28 of the support structure 27 is able to carry the torque and bearing loads of the gearbox 26 and bearings 64 and 78.

FIGS. 5 and 6 show alternative arrangements in which each radially inwardly extending buttress 134 comprises a lattice structure 135. The lattice structure 135 comprises a plurality of walls 136 which form a cellular structure 137. The walls 136 extend radially inwardly from the inner annular wall 30 and between the first and second radially inwardly extending annular flanges 32 and 33. The cellular structure may comprise a plurality of parallelogram cross-sectional shaped cells defined by two sets of intersecting parallel walls 136 as shown in FIG. 5, a plurality of triangular cross-sectional shape cells, a plurality of hexagonal cross-sectional shape cells as shown in FIG. 6, a plurality of rectangular cross-sectional shape cells etc. Each radially outwardly extending buttress 37 may comprise a lattice structure similar to the lattice structure for the radially inwardly extending buttresses 134. The arrangements of FIGS. 5 and 6 work in substantially the same way as the arrangement shown in FIGS. 2 to 4 and have the same advantages. In addition the arrangements have the additional advantages of reduced weight of the stator vane arrangement and improved torque containment compared to the arrangement in FIGS. 2 to 4. The support structures shown in FIGS. 5 and 6 are produced by additive layer manufacturing.

The core engine structure comprises a plurality of axially spaced support structures and casings interconnecting the support structures. Each support structure rotatably mounts one or more of the rotating components, e.g. the fan 13, the intermediate pressure compressor 14, the high pressure compressor 15, the high pressure turbine 17 or the low pressure turbine 18, via a bearing.

Although the present disclosure has referred to the planet gear carrier driving the propulsor, the annulus gear being connected to the support structure and the planet gear carrier being rotatably mounted on the support structure it is equally possible for the annulus gear to drive the fan, the planet gear carrier to be connected to the support structure and the annulus gear to be rotatably mounted on the support structure.

Although the present disclosure has referred to the gearbox driving a fan, it is equally possible for the gearbox to drive another type of propulsor, e.g. a propeller.

Although the present disclosure has referred to the geared gas turbine engine comprising a gearbox, a propulsor, an intermediate pressure compressor, a high pressure compressor, a high pressure turbine and a low pressure turbine, in which the high pressure turbine being arranged to directly drive the high pressure compressor, the low pressure turbine being arranged to directly drive the intermediate pressure compressor and the low pressure turbine being arranged to drive the propulsor via the gearbox other arrangements are possible.

The geared gas turbine engine may comprise a gearbox, a propulsor, an intermediate pressure compressor, a high pressure compressor, a high pressure turbine, an intermediate pressure turbine and a low pressure turbine, in which the high pressure turbine is arranged to directly drive the high pressure compressor, the intermediate pressure turbine is arranged to directly drive the intermediate pressure compressor and the low pressure turbine is arranged to drive the propulsor via the gearbox.

The geared gas turbine engine may comprise a gearbox, a propulsor, a high pressure compressor, a high pressure turbine and a low pressure turbine, in which the high pressure turbine is arranged to directly drive the high pressure compressor and the low pressure turbine is arranged to drive the propulsor via the gearbox.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

What is claimed is:

1. A geared gas turbine engine comprising at least one compressor, at least one turbine, at least one propulsor, a gearbox and a support structure,
the at least one turbine being arranged to drive the at least one compressor, the at least one turbine being arranged to drive the least one propulsor via the gearbox, the at least one propulsor being arranged upstream of the at least one compressor, the gearbox being arranged between the at least one compressor and the at least one propulsor, the at least one propulsor being rotatably mounted in the support structure and the support structure supporting the gearbox,
the support structure including a stator vane arrangement comprising a plurality of circumferentially spaced stator vanes extending radially between an inner annular wall and an outer annular wall, the stator vane arrangement being arranged in flow series between the at least one propulsor and the at least one compressor,
the inner annular wall having a first radially inwardly extending annular flange, a second radially inwardly extending annular flange spaced axially downstream from the first radially extending annular flange and a plurality of circumferentially spaced radially inwardly extending buttresses extending axially from the first radially inwardly extending annular flange to the second radially inwardly extending annular flange,
the outer annular wall having a first radially outwardly extending annular flange, a second radially outwardly extending annular flange spaced axially downstream from the first radially extending annular flange and a plurality of circumferentially spaced radially outwardly extending buttresses extending axially from the first radially outwardly extending annular flange to the second radially outwardly extending annular flange,
the support structure further comprising a first frustoconical member, a second frustoconical member, an annular radially outwardly extending member, a bearing housing and at least one bearing,
the first frustoconical member extending radially inwardly from the first radially inwardly extending annular flange, a radially inner end of the first frustoconical member being secured to and supporting the bearing housing, the at least one propulsor being rotatably mounted by the at least one bearing,
the second frustoconical member extending radially outwardly from the second radially outwardly extending annular flange, the radially inner end of the annular radially outwardly extending member being secured to the outer annular wall downstream of the second radially outwardly extending annular flange and the radially outer end of the second frustoconical member being secured to the radially outer end of the annular radially outwardly extending member.

2. A geared gas turbine engine as claimed in claim 1 wherein each stator vane comprising a radially inner end, a radially outer end, a leading edge, a trailing edge, a first surface extending from the leading edge to the trailing edge and from the radially inner end to the radially outer end and a second surface extending from the leading edge to the trailing edge and from the radially inner end to the radially outer end.

3. A geared gas turbine engine as claimed in claim 2 wherein the first surface being concave between the leading edge and the trailing edge and the second surface being convex between the leading edge and the trailing edge.

4. A geared gas turbine engine as claimed in claim 1 wherein the first radially inwardly extending annular flange and the radially inner ends of the leading edges of the stator vanes being arranged at the same axial position.

5. A geared gas turbine engine as claimed in claim 1 wherein the first radially inwardly extending annular flange being arranged axially downstream of the radially inner ends of the leading edges of the stator vanes.

6. A geared gas turbine engine as claimed in claim 1 wherein the second radially inwardly extending annular flange and the radially inner ends of the trailing edges of the stator vanes being arranged at the same axial position.

7. A geared gas turbine engine as claimed in claim 1 wherein the second radially inwardly extending annular flange being arranged axially upstream of the radially inner ends of the trailing edges of the stator vanes.

8. A geared gas turbine engine as claimed in claim 1 wherein the radially inwardly extending buttresses extending axially downstream from the second radially inwardly extending annular flange.

9. A geared gas turbine engine as claimed in claim 1 wherein each radially inwardly extending buttress being circumferentially aligned with a corresponding one of the stator vanes.

10. A geared gas turbine engine as claimed in claim 1 wherein each radially inwardly extending buttress comprising a lattice structure.

11. A geared gas turbine engine as claimed in claim 1 wherein the first radially outwardly extending annular flange and the radially outer ends of the leading edges of the stator vanes being arranged at the same axial position.

12. A geared gas turbine engine as claimed in claim 1 wherein the first radially outwardly extending annular flange being arranged axially downstream of the radially outer ends of the leading edges of the stator vanes.

13. A geared gas turbine engine as claimed in claim 1 wherein the second radially outwardly extending annular flange and the radially outer ends of the trailing edges of the stator vanes being arranged at the same axial position.

14. A geared gas turbine engine as claimed in claim 1 wherein the second radially outwardly extending annular flange being arranged axially upstream of the radially outer ends of the trailing edges of the stator vanes.

15. A geared gas turbine engine as claimed in claim 1 wherein the radially outwardly extending buttresses extending axially downstream from the second radially outwardly extending annular flange.

16. A geared gas turbine engine as claimed in claim 1 wherein each radially outwardly extending buttress being circumferentially aligned with a corresponding one of the stator vanes.

17. A geared gas turbine engine as claimed in claim 1 wherein each radially outwardly extending buttress comprising a lattice structure.

18. A geared gas turbine engine as claimed in claim 1 wherein the leading edges of the stator vanes being swept, the leading edges of the stator vanes being swept rearwardly.

19. A geared gas turbine engine as claimed in claim 1 wherein the stator vanes being leant.

20. A geared gas turbine engine comprising at least one compressor, at least one turbine, at least one propulsor, a gearbox and a support structure,
the at least one turbine being arranged to drive the at least one compressor, the at least one turbine being arranged to drive the least one propulsor via the gearbox, the at least one propulsor being arranged upstream of the at least one compressor, the gearbox being arranged between the at least one compressor and the at least one propulsor, the at least one propulsor being rotatably mounted in the support structure and the support structure supporting the gearbox,
the support structure including a stator vane arrangement comprising a plurality of circumferentially spaced stator vanes extending radially between an inner annular wall and an outer annular wall, the stator vane arrangement being arranged in flow series between the fan and the at least one compressor,
the inner annular wall having a first radially inwardly extending annular flange, a second radially inwardly extending annular flange spaced axially downstream from the first radially extending annular flange and a plurality of circumferentially spaced radially inwardly extending buttresses extending axially from the first radially inwardly extending annular flange to the second radially inwardly extending annular flange,
the outer annular wall having a first radially outwardly extending annular flange, a second radially outwardly extending annular flange spaced axially downstream from the first radially extending annular flange and a plurality of circumferentially spaced radially outwardly extending buttresses extending axially from the first radially outwardly extending annular flange to the second radially outwardly extending annular flange.

21. A geared gas turbine engine comprising at least one compressor, at least one turbine, at least one propulsor, a gearbox and a support structure,
the at least one turbine being arranged to drive the at least one compressor, the at least one turbine being arranged to drive the least one propulsor via the gearbox, the at least one propulsor being arranged upstream of the at least one compressor, the gearbox being arranged between the at least one compressor and the at least one propulsor, the at least one propulsor being rotatably mounted in the support structure and the support structure supporting the gearbox,
the support structure including a stator vane arrangement comprising a plurality of circumferentially spaced stator vanes extending radially between an inner annular wall and an outer annular wall, the stator vane arrangement being arranged in flow series between the fan and the at least one compressor,
the inner annular wall having a first radially inwardly extending annular flange, a second radially inwardly extending annular flange spaced axially downstream from the first radially extending annular flange and a plurality of circumferentially spaced radially inwardly extending buttresses extending axially from the first radially inwardly extending annular flange to the second radially inwardly extending annular flange, each radially inwardly extending buttress comprising a lattice structure,
the outer annular wall having a first radially outwardly extending annular flange, a second radially outwardly extending annular flange spaced axially downstream from the first radially extending annular flange and a plurality of circumferentially spaced radially outwardly extending buttresses extending axially from the first radially outwardly extending annular flange to the second radially outwardly extending annular flange, each radially outwardly extending buttress comprising a lattice structure
